(19) United States
(12) Patent Application Publication
(10) Pub. No.: US 2015/0101602 A1
(43) Pub. Date: Apr. 16, 2015

(54) COMPACT FILTER ASSEMBLY FOR POSSIBLE USE IN AN AIRCRAFT

(71) Applicant: AVOX Systems Inc., Lancaster, NY (US)

(72) Inventors: William A. Mack, JR., Youngstown, NY (US); William A. Donofrio, Lancaster, NY (US); Eileen M. Farley, Lake View, NY (US); Yelena Aleshina, Williamsville, NY (US)

(21) Appl. No.: 14/511,338

(22) Filed: Oct. 10, 2014

Related U.S. Application Data
(60) Provisional application No. 61/889,652, filed on Oct. 11, 2013.

(51) Int. Cl. A62B 7/10; A62B 21/00; A62B 7/12; A62B 18/02; A62B 7/08; A62B 7/14

(52) U.S. Cl. CPC A62B 7/10; A62B 7/08; A62B 7/14; A62B 7/12; A62B 18/02; A62B 21/00
USPC 128/202.26

(57) ABSTRACT

A filter assembly for use with a chemical oxygen generator. In some embodiments, the filter assembly is external to the chemical oxygen generator. In one embodiment, a first end of the filter assembly includes an inlet that couples to an outlet of chemical oxygen generator and a second end of the filter assembly includes one or more outlets that couple to one or more oxygen masks, tubes or other oxygen-delivery devices. The filter assembly houses a filter media for removing unwanted containments from the generated oxygen. In non-limiting embodiments, the filter assembly is housed in a drop down box or other housing of an aircraft or other desired application.

### CROSS-REFERENCE TO RELATED APPLICATION

This application claims the benefit of U.S. Provisional Application Ser. No. 61/889,652 filed Oct. 11, 2013 and titled “Compact Remote Filter Assembly For Use with a Chemical Oxygen Generator,” the contents of which are incorporated herein by reference.

### RELATED FIELD OF THE INVENTION

Embodiments of the invention generally relate to filter assemblies for use with chemical oxygen generators.

### BACKGROUND

Chemical oxygen generators are configured to release oxygen created by a chemical reaction triggered inside the generator. Chemical oxygen generators are used in a variety of applications and industries, including but not limited to, storing breathing oxygen in aircrafts. A chemical oxygen generator typically includes an internal filter that removes any impurities present in the generated oxygen before the oxygen leaves the generator to be consumed by a passenger or other user.

### SUMMARY OF THE INVENTION

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Disclosed is a filter assembly for use with a chemical oxygen generator. The filter assembly is external to and, in some embodiments, remote from the chemical oxygen generator. The filter assembly is connected to the chemical oxygen generator such that oxygen generated by the chemical oxygen generator passes through the filter assembly after the generated oxygen has exited the generator. In some cases, the filter assembly may be used as a standalone unit.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures, in which use of like reference numerals in different features is intended to illustrate like or analogous components.

FIG. 1 is a perspective view of a filter assembly according to one embodiment.

FIG. 2 is a perspective view of the filter assembly of FIG. 1 arranged within a box and in communication with a chemical oxygen generator and a plurality of oxygen masks.

### DETAILED DESCRIPTION OF THE DRAWINGS

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

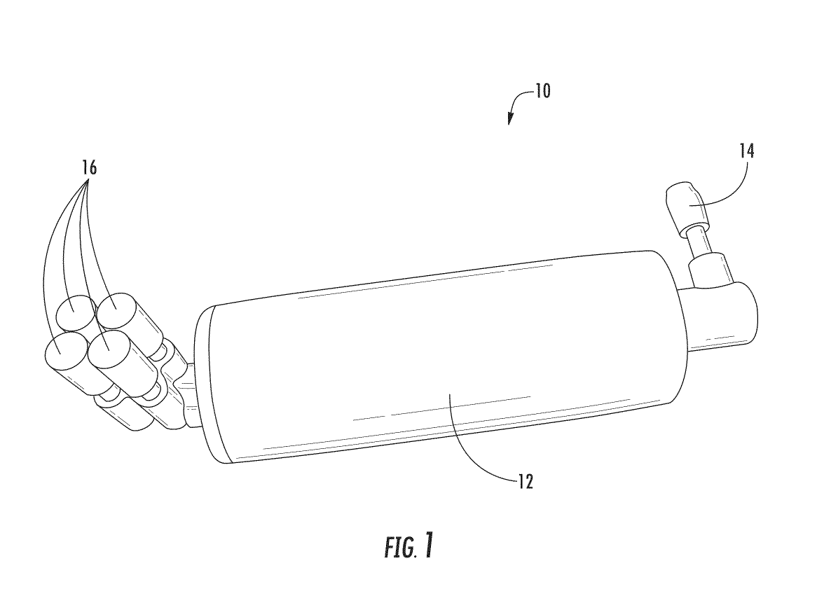

Disclosed herein are filter assemblies for use with chemical oxygen generators. FIG. 1 illustrates one example of a filter assembly 10 that is configured to connect to a chemical oxygen generator. The filter assembly 10 includes a body 12 made of an oxygen-compatible material such as, but not limited to, any suitable metal or plastic. The body 12 of the filter assembly houses a filter media, which can be any suitable media designed to filter unwanted gases or other impurities from oxygen generated by the chemical oxygen generator.

A first end of the filter assembly 10 includes one or more inlets 14 and a second end of the filter assembly 10 includes one or more outlets 16. The one or more inlets 14 is configured to connect to a chemical oxygen generator so that oxygen may enter the one or more inlets 14 after exiting the chemical oxygen generator. After entering the filter assembly 10 through the one or more inlets 14, the oxygen passes through the filter media contained within the body 12 of the filter assembly 10 and then exits the filter assembly 10 via the one or more outlets 16. Each of the one or more outlets 16 may be connected to any suitable number of oxygen masks, tubes, or other devices for facilitating delivery of the generated oxygen to a passenger or other user. The outlets 16 of the filter assembly 10 illustrated in FIG. 1 are in the form of a four-way manifold, but could be a one-way manifold, two-way manifold, three-way manifold, or any suitable number manifold or other outlet.

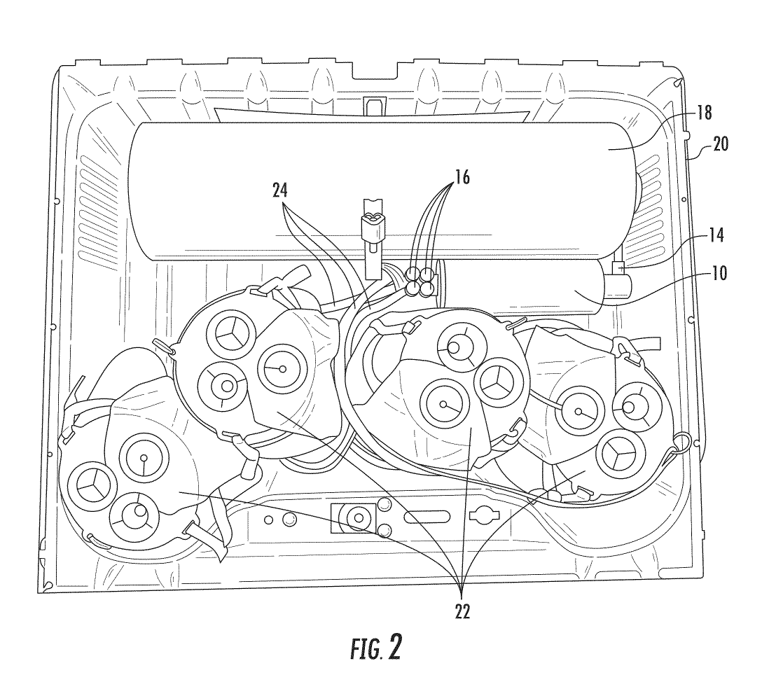

FIG. 2 illustrates an exemplary use of the filter assembly 10. FIG. 2 illustrates a housing 20 that may be stored on an aircraft or used in any other desired application. Housing 20 may be a drop down box or other enclosure. Housing 20 houses the filter assembly 10, a chemical oxygen generator 18, and one or more oxygen masks 22 or other oxygen-delivering devices. As illustrated in FIG. 2, the inlet 14 of the filter assembly 10 connects to the outlet of the chemical oxygen generator 18 and each of the outlets 16 of the filter assembly 10 connects to one or more oxygen masks 22 via tubing 24.

In the event of an emergency or when pressure in the aircraft drops below a predetermined threshold, the housing 20 is configured to open and release oxygen masks 22 so they are accessible to passengers or other users. Since the chemical oxygen generator 18 is contained within the housing 20, the dimensions of the housing 20 are dictated by the dimensions of the chemical oxygen generator 18. Using a filter assembly 10 that is external to, and in some cases remote from, the chemical oxygen generator 18 enables the overall dimensions of the chemical oxygen generator to be reduced. In turn, the dimensions of the housing 20 that houses the chemical oxygen generator 18 can be reduced.

Moreover, by utilizing the disclosed filter assembly 10, the layout of the housing 20 can be modified. In particular, separating the filter from the chemical oxygen generator to reduce the size of the chemical oxygen generator permits a different layout/arrangement of the components within the housing 20. In some cases, the filter assembly 10 may be stored outside of the housing if desired. This enhances the flexibility of the design of the housing.

In addition, because the filter assembly 10 is external to, and in some cases remote from, the chemical oxygen generator, the dimensions of the filter assembly are flexible and are not constrained by the dimensions/configuration of the chemical oxygen generator. Instead, the dimensions and configuration of the filter assembly can vary to best accommodate the configuration of the housing, drop down box or other space in which the filter assembly will be used.

In some embodiments, the filter assembly may be integrated directly as part of the housing/drop down box. For example, the drop down box or other housing can be configured to include a double wall or other structure in one or more of the sides, bottom, or top of the housing, the double wall containing the filter media for removing unwanted containments from the generated oxygen. In other embodiments, the filter assembly is coupled to the outlet of the chemical oxygen generator and is attached as an integral part of the top of the chemical oxygen generator assembly.

Utilizing a filter assembly 10 that is external to the chemical oxygen generator reduces the overall weight of the chemical oxygen generator by eliminating the need for filter media and a filter baffle to be located within the generator. Moreover, separating the filter from the chemical oxygen generator eliminates the characteristic reduction in oxygen production that occurs when the burn front contacts the filter baffle.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

We claim:

1. A chemical oxygen generator assembly comprising:
a chemical oxygen generator comprising a first end and a second end opposite the first end;
a filter assembly that is external to the chemical oxygen generator, the filter assembly comprising:
at least one inlet coupled with the first end of the chemical oxygen generator;
at least one outlet; and
an elongate body between the at least one inlet and the at least one outlet and that includes filter media.

2. The chemical oxygen generator assembly of claim 1, further comprising tubing in communication with the at least one outlet.

3. The chemical oxygen generator assembly of claim 1, wherein the at least one outlet is configured to couple with at least one oxygen mask.

4. The chemical oxygen generator assembly of claim 1, wherein the at least one outlet comprises at least two outlets.

5. The chemical oxygen generator assembly of claim 1, wherein the filter assembly is remote from the chemical oxygen generator.

6. The chemical oxygen generator assembly of claim 1, wherein the elongate body is metal or plastic.

7. A standalone filter assembly for use with a chemical oxygen generator, the standalone filter assembly comprising:
at least one inlet coupled with an outlet of the chemical oxygen generator and configured to receive generated oxygen that has exited the chemical oxygen generator; and
filter media housed within an elongate body that extends between the at least one inlet and at least one filter assembly outlet, wherein the filter media is configured to filter oxygen that passes from the inlet through the filter media,
wherein the at least one filter assembly outlet is configured to facilitate delivery of filtered oxygen to a user.

8. The standalone filter assembly of claim 7, further comprising tubing in communication with the at least one filter assembly outlet.

9. The standalone filter assembly of claim 7, wherein the at least one outlet is configured to couple with at least one oxygen mask.

10. The standalone filter assembly of claim 7, wherein the at least one outlet comprises at least two outlets.

11. The standalone filter assembly of claim 7, wherein the filter assembly is remote from the chemical oxygen generator.

12. The standalone filter assembly of claim 7, wherein the elongate body is metal or plastic.

13. The standalone filter assembly of claim 7, wherein the standalone filter assembly is arranged within a housing and wherein the chemical oxygen generator is also arranged within the housing and is separate from the standalone filter assembly.

14. A method of filtering oxygen, the method comprising:
generating oxygen in a chemical oxygen generator;
filtering the generated oxygen after it exits the chemical oxygen generator by passing the generated oxygen through a filter assembly; and
delivering the filtered oxygen from the filter assembly to a user.

15. The method of claim 14, wherein the generated oxygen passes through an outlet of the chemical oxygen generator before passing through an inlet of the filter assembly.

16. The method of claim 14, wherein the filtered oxygen is delivered via tubing from the filter assembly to one or more oxygen masks.

17. The method of claim 14, wherein the generated oxygen is filtered by passing the generated oxygen through a filter media housed within an elongate body of the filter assembly.

18. The method of filter oxygen of claim 14, further comprising coupling an outlet of the chemical oxygen generator with an inlet of the filter assembly.
